(19) United States
(12) Patent Application Publication
(10) Pub. No.: US 2008/0212160 A1
(43) Pub. Date: Sep. 4, 2008

(54) Electronically Controlled Device With Variable Optical And/Or Power Properties And Power Supply Method Therefor

(75) Inventors: Xavier Fanton, Aulnay Sous Bois (FR); Cecile Rocaniere, Paris (FR); Jean-Marie Tarascon, Mennecy (FR); Aline Rougier, Amiens (FR); Samuel Dubrenat, Paris (FR); Emmanuel Gourba, Paris (FR); Jean-Christophe Giron, Aachen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Saint-Gobain Glass France, Courbevoie (FR)

(21) Appl. No.: 11/817,685

(22) PCT Filed: Mar. 1, 2006
(86) PCT No.: PCT/FR06/50179

§ 371 Date: Jan. 31, 2008

(30) Foreign Application Priority Data
Mar. 3, 2005 (FR) 05500563

(51) Int. Cl. G02F 1/153; G02F 1/163

(52) U.S. Cl. 359/273; 359/275

(57) ABSTRACT

Electrically controllable system having variable optical/energy properties in transmission or reflection, comprising at least one carrier substrate provided with a multilayer allowing the migration of active species, especially an electrochromic multilayer comprising at least two active layers that are separated by at least one layer having an electrolyte function, said multilayer being placed between two electronic conductors connected respectively to current leads, namely lower and upper leads respectively, characterized in that the layer having an electrolyte function incorporates at least one hybrid layer based on a metal layer and on a passivation layer for passivating the same metal as that of the metal layer.

The present invention relates to a method for supplying an electrically controllable device having variable optical and/or energy properties. It relates more particularly to devices using electrochromic systems, whether operating in transmission or in reflection.

Electrochromic systems have been very extensively studied. They are constructed on the following “five-layer” model: TC1/EC1/EL/EC2/TC2, where TC1 and TC2 are electronically conducting materials, EC1 and EC2 are electrochromic materials capable of reversibly and simultaneously inserting cations and electrons, and EL is an electrolyte material that is both an electronic insulator and an ionic conductor. The electronic conductors are connected to an external electrical supply and application of a suitable potential difference between the two electronic conductors causes the system to change color. Under the effect of the potential difference, the ions are ejected from one electrochromic material and inserted into the other electrochromic material, passing via the electrolyte material. The electrons are extracted from one electrochromic material, entering the other electrochromic material via the electronic conductors and the external supply circuit in order to counterbalance the charges and ensure electrical neutrality of the materials.

A modification in their oxidation state as a result of these charge insertions/ejections results in a modification in their optical and/or thermal properties (for example, in the case of tungsten oxide, a switch from a blue color to a colorless appearance and, in the case of iridium oxide, a switch from a yellowish color to a colorless appearance).

The electrochromic system is generally deposited on a transparent or nontransparent support, of organic or mineral nature, which then takes the name “substrate”. In certain cases, two substrates may be used: either each substrate possesses one part of the electrochromic system, and the complete system is obtained by joining the substrates together, or one substrate has the entire electrochromic system and the other is intended to protect the system.

The switching of the electrically controllable system consists of a complex electrochemical process defined by a charge transfer (electrical migration of charged species (ions and electrons) within a thin-film multilayer a few hundred nanometers in thickness) and of a mass transfer, due to the movement of the charged species in the multilayer.

Under the effect of the potential difference, the charge transfer within the electrically controllable system results in an electrochemical equilibrium corresponding to a colored state or a bleached state of the system, and therefore to certain optical properties characterized for example by the level of light transmission (generally expressed in %) achieved.

Now, electrically controllable system manufacturers have developed electrical supplies that deliver potential differences corresponding to operating points for which, on the one hand, optical optimization of the system—color homogeneity, switching speed, contrast—and, on the other hand, mechanical optimization—preservation of these functionalities after several coloring/bleaching cycles (i.e. durability)—are obtained.

Although these systems are entirely satisfactory, manufacturers have noticed that this optimization, both optical and mechanical, does not last over the course of time. For a given operating point, corresponding to a potential difference applied to the terminals of the electrically controllable system, there is a drift over time in the operating point (the optical performance is no longer obtained for this potential value).

Starting from the postulate that it is difficult (or almost impossible) to provide the electrically controllable systems with an optical measurement sensor (especially for measuring the percentage light transmission), the inventors have discovered, quite surprisingly, that it is possible to adapt or modify the operating point of the electrically controllable system, thus making it possible for it to guarantee the optimum performance over the course of time, while obviating any optical measurement.

The object of the present invention is therefore to alleviate the drawbacks of the prior supplies by proposing a novel design of electrically controllable system and a novel design of its method of supply that obviate any variations as a result of a drift in the operating point.

For this purpose, the electrically controllable system having variable optical/energy properties in transmission or reflection, comprising at least one carrier substrate provided with a multilayer allowing the migration of active species, especially an electrochromic multilayer comprising at least two active layers that are separated by at least one layer having an electrolyte function, said multilayer being placed between two electronic conductors connected respectively to current leads, namely lower and upper leads respectively (“lower” corresponding to the current lead closest to the carrier substrate, as opposed to the “upper” current lead, which is furthest from said substrate), is characterized in that the layer having an electrolyte function incorporates at least one hybrid layer based on a metal layer and on a passivation layer for passivating the same metal as that of the metal layer.

Thanks to this hybrid layer incorporated within the layer having an electrolyte function, it is possible to create, within the multilayer forming the electrically controllable system, a third electrode, called a reference electrode, suitable for determining the distribution of the potentials within the system.

In preferred embodiments of the invention, one or more of the following arrangements may optionally be furthermore employed:
the passivation layer includes a cation of the same metal as that of the metal layer;
the passivation layer comprises an oxide of the same metal as that of the metal layer;
the passivation layer comprises a halide, especially a chloride, of the same metal as that of the metal layer;
the passivation layer comprises a sulfate or nitrate of the same metal as that of the metal layer;
the metal is chosen from the following family: all the transition elements lying between column IVB (Ti—Zr—Hf) and column IIB (Zn—Cd—Hg) of the Periodic Table or a mixture of these elements, preferably chosen from the following elements: Cu, Ag, Ni, Al, Ti, Mo, W, Cr, Fe, Co, or a mixture thereof;
the thickness of the hybrid layer is between 5 nm and 300 nm, preferably between 20 and 50 nm;
the layer having an electrolyte function includes at least one layer made of an essentially mineral material;
the hybrid layer is incorporated within the layer made of an essentially mineral material;
the hybrid layer is set back from at least one of the electrochromic layers;
the hybrid layer is at least partly covered with at least one of the electrochromic layers;
the hybrid layer is incorporated within a volume portion of the layer made of essentially mineral material;
the layer having an electrolyte function comprises at least one layer based on a material chosen from tungsten oxide (WO₃), tantalum oxide (Ta₂O₅), antimony oxide (Sb₂O₅), nickel oxide (NiOₓ), tin oxide (SnO₂), zirconium oxide (ZrO₂), aluminum oxide (Al₂O₃), silicon oxide (SiO₂) optionally alloyed with aluminum or boron, niobium oxide (Nb₂O₅), chromium oxide (Cr₂O₃), cobalt oxide (Co₃O₄), titanium oxide (tiO₂), zinc oxide (ZnO) optionally alloyed with aluminum, vanadium oxide (V₂O₅) optionally alloyed with aluminum, and tin zinc oxide (SnZnOₓ), at least one of these oxides being optionally hydrogenated or nitrided;
as well as the layer made of an essentially mineral material, the layer having an electrolyte function includes at least one other layer based on a polymer material based on molten salts;
the other layer of the polymer type is chosen from the family of polyoxyalkylenes, especially polyoxyethylene, or from the family of polyethyleneimines;
the other layer of the polymer type is in the form of an anhydrous or aqueous liquid or based on one or more gels or on one or more polymers, especially an electrolyte of the layer type based on one or more hydrogenated and/or nitrogenated compounds of the POE:H₃PO₄ type, or else a layer based on one or more hydrogenated and/or nitrogenated/PEI:H₃PO₄ compounds, or else on a laminatable polymer;
each electrochemically active layer comprises at least one of the following compounds: tungsten (W) oxide, niobium (Nb) oxide, tin (Sn) oxide, bismuth (Bi) oxide, vanadium (V) oxide, nickel (Ni) oxide, iridium (Ir) oxide, antimony (Sb) oxide and tantalum (Ta) oxide, by itself or as a mixture, and optionally including an additional metal such as titanium, rhenium or cobalt; and
the electronic conductor is of the metallic type or of the TCO (Transparent Conductive Oxide) type, made of In₂O₃:Sn (ITO), SnO₂:F or ZnO:Al, or is a multilayer of the TCO/metal/TCO type, this metal being chosen in particular from silver, gold, platinum, copper, or a multilayer of the NiCr/metal/NiCr type, the metal also being chosen in particular from silver, gold, platinum and copper.

According to another aspect, the subject of the invention is also a method of operating the electrically controllable system as described above.

For this purpose, the method for supplying an electrically controllable system having variable optical/energy properties, in transmission or reflection, comprising at least one carrier substrate provided with a multilayer allowing the migration of active species, especially an electrochromic multilayer comprising at least two active layers that are separated by at least one layer having an electrolyte function incorporating at least one hybrid layer based on a metal layer and on a passivation layer for passivating the same metal as that of the metal layer, the hybrid layer forming a reference electrode, said multilayer being placed between two electronic conductors connected respectively to current leads, namely lower and upper leads respectively (“lower” corresponding to the current lead closest to the carrier substrate, as opposed to the “upper” current lead, which is furthest from said substrate), is characterized in that:
an electrical supply mode denoted by M1, corresponding to one operating point of the electrically controllable system, is applied at a first instant t1 between the current leads, this electrical supply mode giving a first measurement of the electrical supply mode;
at this same first instant t1, a second measurement denoted by Vmes1, corresponding to a potential difference between one of the current leads and the reference electrode, is recorded and at least one quantity characteristic of the electrically controllable system is recorded;
at a second instant t2, which depends on the level of the desired characteristic quantity of the electrically controllable system, an electrical supply mode M2 is applied between the current leads, this electrical supply mode giving a third measurement of the electrical supply mode, and, at this second instant t2, a fourth measurement denoted by Vmes2, corresponding to the potential difference between one of the current leads and the reference electrode, is taken;
this fourth measurement Vmes2 is compared with the second measurement Vmes1; and
the value of the electrical supply mode applied between the current leads is readjusted according to the difference between Vmes2 and Vmes1, so that the potential difference between one of the current leads and the reference electrode is equal to a value selected from a reference table.

In preferred embodiments of the invention, one or more of the following arrangements may optionally be furthermore employed:
the first two steps of the supply method are repeated for a range of V1 selected between V1min and V1max, corresponding to the desired extreme characteristic quantities, in order to obtain for each value of V1 the corresponding value of Vmes1, and a table of reference measurements linking the characteristic quantities with the value of Vmes1 is then produced;
the electrical supply mode that is applied between the current leads is chosen from the voltage supply, the current supply and the charge supply;
the fourth measurement Vmes2 or the second measurement Vmes1 corresponding to a potential difference is taken between the reference electrode and the upper current lead;
the fourth measurement Vmes2 or the second measurement Vmes1 corresponding to a potential difference is taken between the reference electrode and the lower current lead;
the characteristic quantity is chosen from the optical parameters of the electrically controllable system, such as the light transmission;
a table giving the change in the characteristic quantity for various values of the potential difference measured between the lower current lead and the reference electrode is generated;
a table giving the change in the characteristic quantity for various values of the potential difference measured between the upper current lead and the reference electrode is generated; and
a table giving the change in the light transmission for various values of the potential difference measured between the respective lower and upper current leads is generated.

The invention will be described in greater detail in conjunction with the appended figures in which:

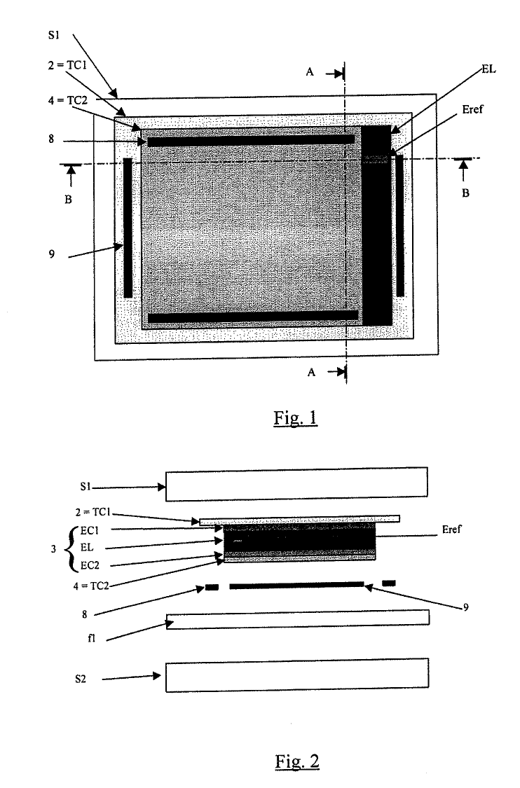

FIG. 1 is a front view of the face 2, forming the subject of the invention;

FIG. 2 is a sectional view on AA of FIG. 1;

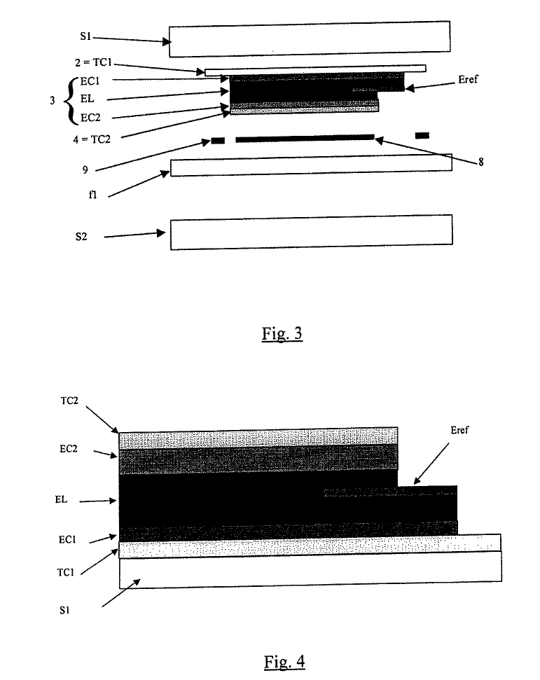

FIG. 3 is a sectional view on BB of FIG. 1;

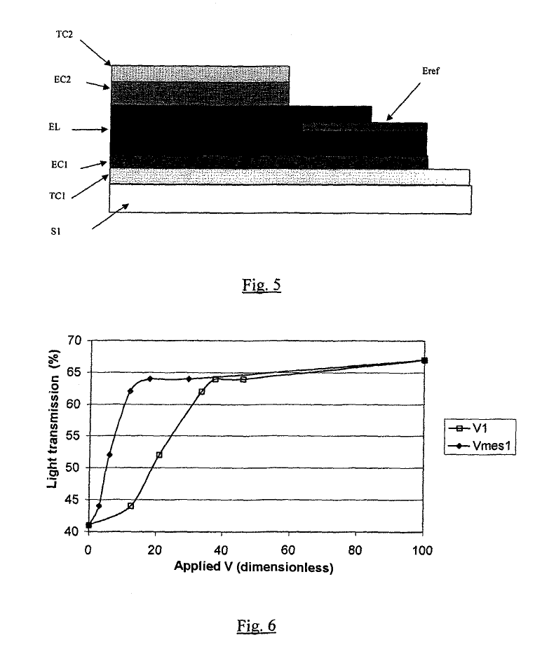

FIGS. 4 and 5 are sectional views illustrating in detail the structure of the active multilayer that incorporates the reference electrode; and

FIG. 6 is a graph showing the variation in light transmission as a function, on the one hand, of the voltage applied across the terminals of the current leads and, on the other hand, the voltage levels obtained between one of the current leads and the reference electrode.

In the appended drawings, certain elements may be shown on a larger or smaller scale than in reality, so as to make it easier to understand the figure.

The example illustrated by FIGS. 1, 2 and 3 relates to an electrochromic window 1. It comprises, in succession from the outside to the inside of the passenger compartment, two panes S1, S2, which are clear soda-lime-silica glass panes (but they may also be tinted), with a thickness for example of 2.1 mm and 2.1 mm respectively.

The glass panes S1 and S2 are of the same size, with dimensions of 150 mm×150 mm.

The glass pane S1 shown in FIGS. 2 and 3 includes, on face 2, a thin-film multilayer of the all-solid-state electrochromic type.

The glass pane S1 is laminated to the glass pane S2 via a thermoplastic sheet f1 made of polyurethane (PU) 0.8 mm in thickness (it may be replaced with a sheet of ethylene/vinyl acetate (EVA) or polyvinyl butyral (PVB)).

The “all-solid-state” electrochromic thin-film multilayer comprises an active multilayer 3 placed between two electronically conducting materials, also called current collectors 2 and 4. The collector 2 is intended to be in contact with face 2.

The collectors 2 and 4 and the active multilayer 3 may either be of substantially the same dimensions and shape, or substantially different dimensions and shape, and it will be understood therefore that the path of the collectors 2 and 4 will be adapted according to the configuration. Moreover, the dimensions of the substrates, in particular of S1, may be essentially greater than those of 2, 4 and 3.

The collectors 2 and 4 are of the metallic type or of the TCO (Transparent Conductive Oxide) type, made of In₂O₃:Sn (ITO), SnO₂:F or ZnO:Al, or a multilayer of the TCO/metal/TCO type, this metal being chosen in particular from silver, gold, platinum and copper. It may also be a multilayer of the NiCr/metal/NiCr type, the metal also being chosen in particular from silver, gold, platinum and copper.

Depending on the configurations, they may be omitted, and in this case current leads are directly in contact with the active multilayer 3.

The window 1 incorporates current leads 8, 9, which allow the active system to be controlled via an electrical supply. These current leads are of the type of those used for heated windows (namely shims, wires or the like).

One preferred embodiment of the collector 2 consists in depositing, on face 2, a 50 nm SiOC first layer surmounted by a 400 nm SnO₂:F second layer (both layers preferably being deposited in succession by CVD on the float glass before cutting).

A second embodiment of the collector 2 consists in depositing, on face 2, a bilayer consisting of an approximately 20 nm SiO₂-based first layer which may or may not be doped (especially doped with aluminum or boron) surmounted by an approximately 100 to 600 nm ITO second layer (both layers preferably being vacuum-deposited in succession by magnetron reactive sputtering in the presence of oxygen, optionally carried out hot).

Another embodiment of the collector 2 consists in depositing, on face 2, an approximately 100 to 600 nm monolayer consisting of ITO (a layer preferably vacuum-deposited by magnetron reactive sputtering in the presence of oxygen, optionally carried out hot).

The collector 4 is a 100 to 500 nm ITO layer again deposited by magnetron reactive sputtering on the active multilayer.

The active multilayer 3 shown in FIGS. 2, 3, 4 and 5 is made up as follows, according to a first embodiment shown in FIG. 4:
a 100 to 300 nm layer of anodic electrochromic material made of nickel oxide, which layer may or may not be alloyed with other metals;
a 100 nm layer of hydrated tantalum oxide or hydrated silica oxide or hydrated zirconium oxide, or a mixture of these oxides; and
a 200 to 500 nm, preferably 300 to 400 nm, especially about 370 nm, layer of cathodic electrochromic material based on tungsten oxide.

According to a second embodiment, shown in FIG. 5, the active multilayer 3 is made up as follows:
a 100 to 300 nm layer of anodic electrochromic material made of nickel oxide, which layer may or may not be alloyed with other metals;
a 100 nm layer of hydrated tungsten oxide;
a 100 nm layer of hydrated tantalum oxide or hydrated silica oxide or hydrated zirconium oxide or a mixture of these oxides; and
a 200 to 500 nm, preferably 300 to 400 nm, especially about 370 nm, layer of cathodic electrochromic material based on hydrated tungsten oxide.

Irrespective of the embodiment of the electrically controllable system, and in particular the active multilayer shown in detail in FIGS. 4 and 5, the layer acting as electrolyte incorporates a reference electrode (called Eref in the figures). This reference electrode is in fact formed from a hybrid layer, with a thickness of between 5 nm and 300 nm, preferably between 20 and 50 nm, based on a metal layer and on passivation layer includes a cation of the same metal as that of the metal layer. The metal may be chosen from the following family: all the transition elements lying between column IVB (Ti—Zr—Hf) and column IIB (Zn—Cd—Hg) of the Periodic Table or a mixture of these elements, preferably chosen from the following elements: Cu, Ag, Ni, Al, Ti, Mo, W, Cr, Fe, Co, or a mixture of these, and in the embodiments shown in FIGS. 1 to 5 there is an Ni/NiO reference electrode.

The active multilayer 3 may be incised over all or part of its periphery with grooves produced by mechanical means or by etching using laser radiation, optionally pulsed laser radiation, for the purpose of limiting peripheral electrical leakage, as described in French Application FR-2 781 084.

Moreover, the window shown in FIGS. 1, 2 and 3 incorporates (not shown in the figures) a first peripheral seal in contact with faces 2 and 3, this first seal being suitable for providing a barrier to external chemical attack.

A second peripheral seal is in contact with the edge of S1, the edge of S2 and face 4, so as to produce: a barrier; a means for fitting it into the vehicle; sealing between the inside and the outside; an esthetic function; and a means of incorporating the reinforcing elements.

In other embodiments, the “all-solid-state” active multilayer 3 may be replaced with other families of electrochromic materials of the polymer type.

Thus, for example, a first part formed from a 10 to 10,000 nm, preferably 50 to 500 nm, layer of electrochromic material, also called the active layer, made of poly(3,4-ethylenedioxythiophene)—as a variant it may be one of the derivatives of this polymer—is deposited by known liquid deposition techniques (spray coating, dip coating, spin coating or casting), or by electrodeposition, on a substrate coated with its current collector, it being possible for this current collector to be a lower conducting layer or an upper conducting layer forming the electronic conductor (the anode or the cathode), optionally provided with wires or the like. Whatever the polymer constituting this active layer, this polymer is particularly stable, especially to UV, and operates by insertion/ejection of lithium ions (Li⁺) or alternatively of H³⁰ ions.

A second part acting as electrolyte, and formed from a layer with a thickness of between 50 nm and 2000 nm, and preferably between 50 nm and 1000 nm, is deposited by a known liquid deposition technique (spray coating, dip coating, spin coating or casting) between the first and third parts on the first part or else by injection. This second part is based on a polyoxyalkylene, especially polyoxyethylene. It may be combined with a layer of mineral-type electrolyte, for example based on hydrated tantalum oxide, zirconium oxide or silicon oxide.

This second electrolyte part deposited on the active layer of electrochromic material, itself supported by the glass or similar substrate, is then coated with a third part, the constitution of which is similar to the first part, namely this third part is made up of a substrate coated with a current collector (conducting wires, or conducting wires plus conducting layer, or only conducting layer), this current collector itself being covered with an active layer.

On the basis of this hybrid (polymer/mineral) electrochromic multilayer, it is proposed to incorporate the reference electrode described above within the mineral-type electrolyte layer.

This example corresponds to a window operating by proton transfer. It consists of a first glass substrate 1, made of 4 mm soda-lime-silica glass, followed in succession by:
a 300 nm electronically conducting first SnO₂:F layer;
a 185 nm anodic first layer of electrochromic material made of hydrated nickel oxide NiOₓH_{y} (it could be replaced with a 55 nm layer of hydrated iridium oxide);
an electrolyte made up of a 70 nm first layer of hydrated tantalum oxide, a 100 micron second layer of POE/H₃PO₄ polyoxyethylene/phosphoric acid solid solution or alternatively a PEI/H₃PO₄ polyethylene imine/phosphoric acid solid solution; combined with
a 100 nm layer of hydrated tantalum oxide or hydrated silica oxide or hydrated zirconium oxide or a mixture of these oxides;
a 350 nm second layer of cathodic electrochromic material based on tungsten oxide; and
a 300 nm second SnO₂:F layer followed by a second glass substrate identical to the first.

In this example, there is therefore a bilayer electrolyte based on a polymer normally used in this type of glazing, which is “lined” with a layer of hydrated tantalum oxide that is sufficiently conducting not to impair proton transfer via the polymer and that protects the counterelectrode made of anodic electrochromic material from direct contact with the latter, the intrinsic acidity of which would be prejudicial thereto.

Instead of the hydrated Ta₂O₅ layer, a layer of the hydrated Sb₂O₅ or TaWOₓ type may be used.

It is also possible to provide a three-layer electrolyte, with two hydrated oxide layers, either with one of them on each side of the polymer layer, or with the two layers superposed one on the other on the side facing the layer of anodic electrochromic material.

The electrically controllable structure as described above with its reference electrode permits an innovative operation mode based on a comparison of the operation of the system at instant t with its operation relative to a preestablished knowledge model.

The first step therefore consists in establishing a database, namely a knowledge model of the electrically controllable system.

A supply mode is applied between the current leads of the electrically controllable system. Conventionally, this is a voltage source or a current source or a charge source.

To give an example, a first voltage level denoted by V1 is therefore applied. For this voltage level V1, a characteristic quantity of the system is recorded by appropriate means. This may be an optical property such as for example a light transmission level.

A light transmission level is therefore associated with this voltage level V1.

In parallel with this voltage level V1, the voltage between the reference electrode and each of the current leads is recorded, this being associated with the lower electronic conductor and upper electronic conductor respectively.

For any one light transmission level there are therefore three voltage levels (between the current leads, and between the reference electrode and each of the current leads).

These four data items are stored in a table.

Next, the voltage level is incremented between a minimum value and a maximum value, and for each of these voltage levels the entire database characteristic of the operating points of the electrically controllable system is constructed.

The actual operation phase consists in comparing the voltage levels obtained at an instant t across the terminals of the current leads and the reference electrode with the operating values of the knowledge model.

One operating mode may be the following:
at an instant t, a voltage level is applied between the current leads corresponding to a certain light transmission level. At this same t, the value of the voltage level between the reference electrode and one of the current leads, denoted by Vmes1, is recorded.

If it is necessary to modify the level of the characteristic quantity, the light transmission level for example to be modified the voltage level applied across the terminals of the current leads.

At this instant t2, the level Vmes2 at the reference electrode and the current lead identical to that used for Vmes1 is recorded.

Vmes1 and Vmes2 are then compared and, depending on the difference, the level of the voltage applied between the current leads is readjusted so that the potential difference between one of the current leads and the reference electrode is equal to a value selected from a reference table.

Given below is a table of voltage levels between, on the one hand, the two current leads (namely V1, which varies between V1min and V1max) and, on the other hand, voltage levels measured between one of the current leads and the reference electrode, Vmes1. Each measurement has been normalized between 0 and 100, namely 100 corresponds to V1max and 0 corresponds to V1min. The Vmes1 measurements have also been normalized between 0 and 100 by the extreme values of Vmes1.

| TL (%) | V1 | Vmes1 |
|---|---|---|
| 67 | 100.0 | 100 |
| 64 | 45.8 | 29.4 |
| 64 | 37.5 | 17.6 |
| 62 | 33.3 | 11.8 |
| 52 | 20.8 | 5.9 |
| 44 | 12.5 | 2.9 |
| 41 | 0 | 0 |

As can be seen in the graph of FIG. 6, the operation of the electrically controllable system is improved if the choice is based on the V1 level, taking into account the Vmes1 voltage level, which optimizes the desired TL level.

The electrically controllable system as described may be incorporated within a glazing assembly having in particular a variable light and/or energy transmission and/or reflection, this glazing assembly consisting of at least one substrate in which at least one part of the substrate is transparent or partially transparent, made of glass or plastic, preferably mounted as multiple and/or laminated glazing, or as double glazing. It is also possible to combine this glazing assembly with at least one other layer suitable for providing an additional functionality (solar control, low emissivity, hydrophobicity, hydrophilicity, antireflection).

These glazing assemblies are used as architectural glazing, automotive glazing, windows for industrial or rail, sea or air mass-transit vehicles, rear-view mirrors, or other mirrors.

1. An electrically controllable system having variable optical/energy properties in transmission or reflection, comprising at least one carrier substrate provided with a multilayer allowing the migration of active species, especially an electrochromic multilayer comprising at least two active layers that are separated by at least one layer having an electrolyte function, said multilayer being placed between two electronic conductors connected respectively to current leads, namely lower and upper leads respectively (“lower” corresponding to the current lead closest to the carrier substrate, as opposed to the “upper” current lead, which is furthest from said substrate), characterized in that the layer having an electrolyte function incorporates at least one hybrid layer based on a metal layer and on a passivation layer for passivating the same metal as that of the metal layer.

2. The system as claimed in claim 1, characterized in that the passivation layer includes a cation of the same metal as that of the metal layer.

3. The system as claimed in claim 1, characterized in that the passivation layer comprises an oxide of the same metal as that of the metal layer.

4. The system as claimed in claim 1, characterized in that the passivation layer comprises a halide, especially a chloride, of the same metal as that of the metal layer.

5. The system as claimed in claim 1, characterized in that the passivation layer comprises a sulfate or nitrate of the same metal as that of the metal layer.

6. The system as claimed in claim 1, characterized in that the metal is chosen from the following family: all the transition elements lying between column IVB (Ti—Zr—Hf) and column IIB (Zn—Cd—Hg) of the Periodic Table or a mixture of these elements, thereof.

7. The system as claimed in claim 1, characterized in that the thickness of the hybrid layer is between 5 nm and 300 nm, preferably between 20 and 50 nm.

8. The system as claimed in claim 1, characterized in that the layer having an electrolyte function includes at least one layer made of an essentially mineral material.

9. The system as claimed in claim 8, characterized in that the hybrid layer is incorporated within the layer made of an essentially mineral material.

10. The system as claimed in claim 9, characterized in that the hybrid layer is set back from at least one of the electrochromic layers.

11. The system as claimed in claim 9, characterized in that the hybrid layer is at least partly covered with at least one of the electrochromic layers.

12. The system as claimed in claim 1, characterized in that the hybrid layer is incorporated within a volume portion of the layer made of essentially mineral material.

13. The system as claimed in claim 1, characterized in that the layer having an electrolyte function comprises at least one layer based on a material chosen from tungsten oxide (WO₃), tantalum oxide (Ta₂O₅), antimony oxide (Sb₂O₅), nickel oxide (NiOₓ), tin oxide (SnO₂), zirconium oxide (ZrO₂), aluminum oxide (Al₂O₃), silicon oxide (SiO₂) optionally alloyed with aluminum or boron, niobium oxide (Nb₂O₅), chromium oxide (Cr₂O₃), cobalt oxide (Co₃O₄), titanium oxide (TiO₂), zinc oxide (ZnO) optionally alloyed with aluminum, vanadium oxide (V₂O₅) optionally alloyed with aluminum, and tin zinc oxide (SnZnOₓ), at least one of these oxides being optionally hydrogenated or nitrided.

14. The system as claimed in claim 1, characterized in that the layer having an electrolyte function includes at least one other layer based on a polymer material based on molten salts.

15. The system as claimed in claim 14, characterized in that the other layer of the polymer type is chosen from the family of polyoxyalkylenes, especially polyoxyethylene, or from the family of polyethyleneimines.

16. The system as claimed in claim 1, characterized in that the other layer of the polymer type is in the form of an anhydrous or aqueous liquid or based on one or more gels or on one or more polymers, especially an electrolyte of the layer type based on one or more hydrogenated and/or nitrogenated compounds of the POE:H₃PO₄ type, or else a layer based on one or more hydrogenated and/or nitrogenated/PEI:H₃PO₄ compounds, or else on a laminatable polymer.

17. The system as claimed in claim 1, characterized in that the electrochemically active layer comprises at least one of the following compounds: tungsten (W) oxide, niobium (Nb) oxide, tin (Sn) oxide, bismuth (Bi) oxide, vanadium (V) oxide, nickel (Ni) oxide, iridium (Ir) oxide, antimony (Sb) oxide and tantalum (Ta) oxide, by itself or as a mixture, and optionally including an additional metal such as titanium or rhenium.

18. The system as claimed in claim 1, characterized in that the electronic conductor is of the metallic type or of the TCO type, made of In₂O₃:Sn (ITO), SnO₂:F or ZnO:Al, or is a multilayer of the TCO/metal/TCO type, this metal being chosen in particular from silver, gold, platinum, copper, or a multilayer of the NiCr/metal/NiCr type, the metal also being chosen in particular from silver, gold, platinum and copper.

19. Electrochromic glazing, characterized in that it includes the electrically controllable system as claimed in claim 1, having in particular a variable light and/or energy transmission and/or reflection, with the substrate or at least one part of the substrates being transparent or partially transparent, made of glass or plastic, preferably mounted as multiple and/or laminated glazing, or as double glazing.

20. Electrochromic glazing, which includes the electrochemical system as claimed in claim 1, characterized in that it is combined with at least one other layer suitable for providing said glazing with an additional functionality (solar control, low emissivity, hydrophobicity, hydrophilicity, antireflection).

21. A method for supplying an electrically controllable system having variable optical/energy properties as claimed in claim 1, comprising at least one carrier substrate provided with a multilayer allowing the migration of active species, especially an electrochromic multilayer comprising at least two active layers that are separated by at least one layer having an electrolyte function incorporating at least one hybrid layer based on a metal layer and on a passivation layer for passivating the same metal as that of the metal layer, the hybrid layer forming a reference electrode, said multilayer being placed between two electronic conductors connected respectively to current leads, namely lower and upper leads respectively (“lower” corresponding to the current lead closest to the carrier substrate, as opposed to the “upper” current lead, which is farthest from said substrate), characterized in that:
an electrical supply mode denoted by M1, corresponding to one operating point of the electrically controllable system, is applied at a first instant t1 between the current leads, this electrical supply mode giving a first measurement of the electrical supply mode;
at this same first instant t1, a second measurement denoted by Vmes1, corresponding to a potential difference between one of the current leads and the reference electrode, is recorded and at least one quantity characteristic of the electrically controllable system is recorded;
at a second instant t2, which depends on the level of the desired characteristic quantity of the electrically controllable system, an electrical supply mode M2 is applied between the current leads, this electrical supply mode giving a third measurement of the electrical supply mode, and, at this second instant t2, a fourth measurement denoted by Vmes2, corresponding to the potential difference between one of the current leads and the reference electrode, is taken;
this fourth measurement Vmes2 is compared with the second measurement Vmes1; and
the value of the electrical supply mode applied between the current leads is readjusted according to the difference between Vmes2 and Vmes1, so that the potential difference between one of the current leads and the reference electrode is equal to a value selected from a reference table.

22. The supply method as claimed in claim 21, characterized in that the first two steps of the supply method are repeated for a range of V1 selected between V1min and V1max, corresponding to the desired extreme characteristic quantities, in order to obtain for each value of V1 the corresponding value of Vmes1, and a table of reference measurements linking the characteristic quantities with the value of Vmes1 is then produced.

23. The method as claimed in claim 21, characterized in that the electrical supply mode that is applied between the current leads is chosen from the voltage supply, the current supply and the charge supply.

24. The method as claimed in claim 21, characterized in that the fourth measurement Vmes2 or the second measurement Vmes1 corresponding to a potential difference is taken between the reference electrode and the upper current lead.

25. The method as claimed in claim 21, characterized in that the fourth measurement Vmes2 or the second measurement Vmes1 corresponding to a potential difference is taken between the reference electrode and the lower current lead.

26. The method as claimed in claim 21, characterized in that the characteristic quantity is chosen from the optical parameters of the electrically controllable system, such as the light transmission.

27. The method as claimed in claim 21, characterized in that a table giving the change in the characteristic quantity for various values of the potential difference measured between the lower current lead and the reference electrode is generated.

28. The method as claimed in claim 21, characterized in that a table giving the change in the characteristic quantity for various values of the potential difference measured between the upper current lead and the reference electrode is generated.

29. The method as claimed in claim 21, characterized in that a table giving the change in the light transmission for various values of the potential difference measured between the respective lower and upper current leads is generated.

30. The use of the glazing as claimed in claim 19 as architectural glazing, automotive glazing, windows for industrial or rail, sea or air mass-transit vehicles, rear-view mirrors, or other mirrors.
